(19) United States
(12) Patent Application Publication
(10) Pub. No.: US 2015/0059964 A1
(43) Pub. Date: Mar. 5, 2015

(54) Treatment of elasticated bindings for bird carcasses

(71) Applicant: Stuart Baird Revill, Swadlincote (GB)

(72) Inventor: Stuart Baird Revill, Swadlincote (GB)

(21) Appl. No.: 14/381,733

(22) PCT Filed: Mar. 8, 2013
(86) PCT No.: PCT/GB13/00100

§ 371 Date: Aug. 28, 2014

(30) Foreign Application Priority Data
Mar. 10, 2012 (GB) 1204301.4

(51) Int. Cl. B32B 38/00; A22C 21/00

(52) U.S. Cl. CPC B32B 38/0036; A22C 21/0038; B32B 2307/51
USPC 156/155

(57) ABSTRACT

A bundle of chicken loops (10) have their cut ends presented to a heat gun (14) so that “featherings” of textile material which have unraveled from the rubber core are melted away.

This invention relates to a treatment of elasticated bindings for bird carcasses. Elasticated bindings are used to hold the wings and legs of a bird close to the carcass during cooking and can then be removed prior to carving.

A ribbon of natural or synthetic rubber is covered with helical windings of a textile strand, such as of cotton or polyester, and then cut into lengths. The helical windings allow the rubber a degree of stretch without exposing the rubber, which might otherwise melt and contaminate the carcass. The two ends of each length are then knotted together to make what is called in the trade a “chicken loop” although it will be understood that chicken loops can be used to bind the carcasses of birds other than chickens.

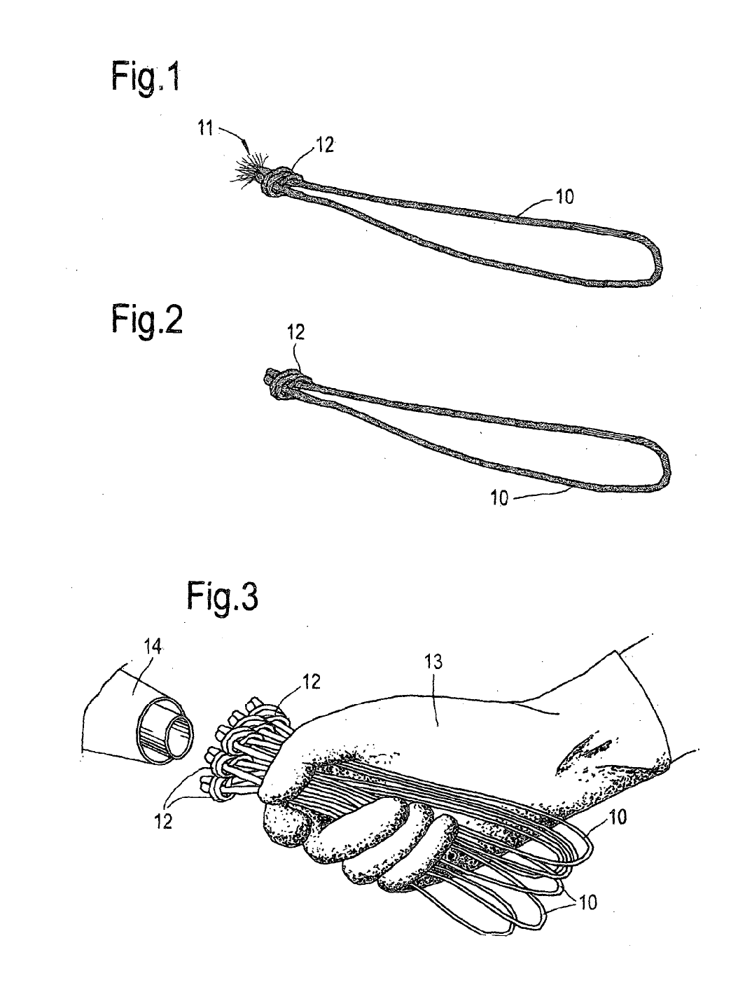

To withstand the high temperature of an oven each textile strand is made up of multiple filaments and typically multiple strands are wound onto the rubber in helices of opposite hand. A problem in the use of such textile-covered lengths of rubber is that where they are cut the filaments tend to unravel and project beyond the rubber in an unsightly “feathering”. This is illustrated by FIG. 1 of the accompanying drawings. There is some danger that bits of the filaments will become detached and remain on the carcass after removal of the loop. This may not present a health problem but consumers will naturally dislike it.

Hitherto the only solution to the problem has been manually to trim the “feathering” off each loop where it extends beyond the knot. This however is a very labour intensive and time consuming operation. The manufacture, the cutting and the knotting of the loops can all be done mechanically, so that the manual trimming of the loops will greatly add to their cost.

A principal object of the present invention is to provide a better and more economical solution to the problem.

In accordance with the invention there is provided a method of treating the cut ends of a textile-covered length of an elastic material which comprises subjecting said ends to heat sufficient and for sufficient time to destroy filaments of the textile where these extend beyond the elastic material.

The elastic material may be natural or synthetic rubber and the textile may be made of a plastics material, such as a polyester fibre.

The textile covering may be provided by winding strands of the textile helically about the elastic material. Preferably each strand comprises multiple textile filaments and multiple strands may be wound on to the elastic material in helices of opposite hand.

The source of heat is preferably a device which blows air at a temperature sufficient to destroy but not to ignite the textile material. The device is preferably a heat gun with an output in the region of 1400 degrees F.

End regions of the textile-covered length may be knotted together and jointly presented to the heat source

Bundles of the knotted lengths may have their cut ends jointly presented to the source of heat

A preferred embodiment of the invention will now be described by way of non-limitative example with reference to the accompanying diagrammatic drawings, in which:

FIG. 1 illustrates a chicken loop prior to the treatment of the present invention;

FIG. 2 illustrates the chicken loop of FIG. 1 after the treatment of the present invention, and

FIG. 3 illustrates a preferred way of carrying out the method of the present invention.

The chicken loop 10 of FIGS. 1 and 2 consists of a length of synthetic rubber covered by helically wound strands of polyester filaments. Each strand comprises multiple filaments 11 and multiple strands are wound round the rubber in helices of opposite hand. The helical windings allow the rubber a degree of stretch without exposure of the rubber.

To make the loop 10 a continuous ribbon of the covered rubber has been cut to length and then the cut ends have been joined at the knot 12. Where the cut ends project from the knot 12 a “feathering” of filaments 11 have unravelled from and extend beyond the rubber.

In accordance with the present invention a bundle of the loops 10 have their cut ends jointly presented to a source of heat 14. This heat source 14 is a heat gun which blows out hot air at a temperature in the region of 1400 degrees F. Holding the bundle in a gloved hand 13 the operator moves the bundle to and fro through the jet of hot air until all or most of the “feathering” of filaments 11 is melted off. Each loop 10 is then as illustrated in FIG. 2. No loose filaments 11 project beyond the cut ends of the rubber.

The treatment of the present invention provides a less unsightly chicken loop and the danger of fragments of the textile adhering to the bird is obviated.

Particularly when a rotisserie oven is used for the cooking it is important to remove the “feathering” of a loop in case this should catch fire and consequently ignite the fats exuded by the bird during cooking.

1. A method of treating the cut ends of a textile-covered length of an elastic material which comprises subjecting said ends to heat sufficient and for sufficient time to destroy filaments of the textile where these extend beyond the elastic material, the source of heat being a device which blows air at a temperature sufficient to destroy, but not to ignite the textile material.

2. A method as claimed in claim 1 wherein end regions of the textile-covered lengths are knotted together to be jointly presented to the source of heat.

3. A method as claimed in claim 1 wherein said device is a heat gun with an output of approximately 1400 degrees F.

4. A method as claimed in claim 1, wherein the elastic material is natural or synthetic rubber and the textile is made of a plastic material.

5. A method as claimed in claim 4 wherein the plastic material is a polyester fiber.

6. A method as claimed in claim 1, wherein the textile covering is provided by winding strands of the textile helically about the elastic material.

7. A method as claimed in 6, wherein each strand comprises multiple textile filaments.

8. A method as claimed in claim 1, wherein the textile covering comprises multiple helical strands of opposite hand.

9-11. (canceled)
